(19) United States
(12) Patent Application Publication
(10) Pub. No.: US 2022/0092537 A1
(43) Pub. Date: Mar. 24, 2022

(54) MATERIAL DISTRIBUTION METHOD BASED ON WORKSTATION GROUP DIVISION

(71) Applicant: Shandong University of Science and Technology, Qingdao, Shandong (CN)

(72) Inventors: Meiyan Li, Qingdao, Shangdong (CN); Junjie Huang, Qingdao, Shandong (CN); Jiaxin Chong, Qingdao, Shandong (CN); Ruiai Nie, Qingdao, Shandong (CN); Xinpeng Han, Qingdao, Shandong (CN); Chuan Luo, Qingdao, Shandong (CN); Qingwen Wang, Qingdao, Shandong (CN)

(21) Appl. No.: 16/966,660

(22) PCT Filed: Jul. 24, 2019
(86) PCT No.: PCT/CN2019/097474

§ 371 Date: Jul. 31, 2020

(30) Foreign Application Priority Data
Jun. 6, 2019 (CN) 201910488643.8

(51) Int. Cl. G06Q 10/08; G06Q 10/04

(52) U.S. Cl. CPC G06Q 10/0875; G06Q 10/047; G06Q 10/083

(57) ABSTRACT

A material distribution method based on workstation group division. The method includes the following steps: step 1: performing statistics on the number and models of online products, and taking the number of the online products as an indicator of a production process; step 2: obtaining material requirements of each product according to a bill of materials (BOM) of the product; step 3: checking specific information on each type of material and transportation means according to the BOM, establishing a mathematical model according to the specific information and the number of materials consumed, and planning material distribution; step 4: planning a distribution route of each workstation group according to the workstation group division; step 5: establishing a mathematical model according to material attribute analysis, pick frequency analysis, inter-material correlation and a material storage mode to optimize a storage location of a warehouse; step 6: distributing materials according to a work flow.

### CROSS REFERENCE TO RELATED APPLICATIONS

This application is a national phase entry of and claims benefit to international PCT Application Number PCT/CN2019/097474 filed Jul. 24, 2019, entitled “MATERIAL DISTRIBUTION METHOD BASED ON WORKSTATION GROUP DIVISION”, which claims the benefit of priority of Chinese Patent Application No. 201910488643.8, filed Jun. 6, 2019. This PCT application and this Chinese application are hereby incorporated by reference in their entirety for all intents and purposes.

### TECHNICAL FIELD

The present invention relates to the field of material distribution in mixed-model assembly workshops, and in particular, to a material distribution method based on workstation group division.

### BACKGROUND

As the market competition is daily intensifying and science and technology is rapidly developing, mixed-model assembly production of multiple varieties and small batches has become an effective means for enterprises to respond to customers' diversified and personalized needs quickly. A mixed-model assembly line is a flexible production system that can continuously produce different types of products on the same production line in a hybrid manner. It can not only improve production efficiency and expand production capacity, but also meet the requirements for assembly of multiple varieties and specifications. The mixed-model assembly line has certain flexibility and adaptability, and also increases the difficulty in timely material distribution. For modern complex mixed-model assembly lines, a reasonable material scheduling solution is the key to ensure the timely distribution of materials. On the basis of normal operation of the mixed-model assembly line, optimizing driving paths of distribution vehicles, shortening the distribution time and improving the utilization rate of the distribution vehicles are of great significance for optimizing a material scheduling solution and implementing the just-in-time production mode.

The existing distribution mode is that according to a production plan, materials needed for the production on the same day are stored in a temporary storage area inside a factory, and then distribution personnel of the factory send the materials to a production line side, select the material distribution order and quantity of distributed materials as per experience, and urge, if there is an urgent lacking of materials at the line side, relevant personnel to feed material to ensure normal production. Rules for material storage in the storage area are simple and the materials are divided according to categories.

The solution has the following shortcomings.

There is no design optimization for the material distribution scheduling solution. The materials distributed may not necessarily be required for actual production, and the required materials may not be distributed in place. This will lead to excessive accumulation of materials at the line side and failure to timely distribute materials required by the line side.

Due to the unstable production rhythm and the lack of good material scheduling design optimization, the distribution of work tasks for the distribution personnel is extremely uncoordinated. When there is a demand for emergency distribution of multiple materials, the distribution personnel are busy, while when there is no demand for emergency distribution, the distribution personnel are idle.

The distribution personnel cannot know the consumption of materials at the line side. When there are multiple notices on emergency material lacking at the same time, it may result in that distribution personnel cannot distribute materials timely, leading to shutdown of the production line caused by material lacking.

There is no reasonable plan for a warehouse, which leads to the problems of error in material picking, low efficiency, etc.

### SUMMARY

In view of the shortcomings, the present invention provides a material distribution method based on workstation group division. The distribution method enables the types and quantities of materials distributed to be more reasonable by design optimization of a distribution scheduling solution, thereby ensuring that a mixed-model assembly line is not subjected to material lacking and shutdown in the production process.

The present invention specifically adopts the following technical solutions:

A material distribution method based on workstation group division, including the following steps:

step 1: setting a radio frequency identification (RFID) scanner at the first workstation where a production line starts, performing statistics on the number and models of online products, and taking the number of the online products as an indicator of a production process;

step 2: obtaining material requirements of each product according to a bill of materials (BOM) of the product, mapping the required materials to each workstation, and accordingly calculating material consumption at each material consumption workstation when an i-th product is produced;

step 3: checking specific information on each type of material and transportation means according to the BOM, establishing a mathematical model according to the specific information and the number of materials consumed, planning material distribution, and distributing materials for a workstation group Zⱼ composed of the material consumption workstations when the i-th product is produced;

step 4: planning a distribution route of each workstation group according to the workstation group division;

step 5: obtaining a distribution frequency of each type of material according to the workstation group division, and establishing a mathematical model according to material attribute analysis, pick frequency analysis, inter-material correlation and a material storage mode to optimize a storage location of a warehouse; and

step 6: dividing staff into warehouse material preparation personnel and distribution personnel, and distributing materials according to a work flow.

Preferably, in step 3, the specific information on each type of material and transportation means includes information on material storage containers, types and sizes of material boxes, modes of combination of the material boxes, the number of stored materials and transportation capacity of the transportation means.

Preferably, the workstation group division specifically includes: calculating a material demand lackᵢₙ of an n-th material consumption workstation for the production of an i-th product through the quantity of materials consumed for products, planning according to information on a material demand Coₙ of an n-th type of material for a unit product, a quantity Caₙ of materials in a unit material box, a material box volume Vₙ and a maximum carrying capacity Q of transportation means; when the number of material lacking boxes is equal to or greater than the maximum carrying capacity Q of the transportation means, distributing materials; where at this time, transportation workstations form a transportation workstation group; updating the material lacking quantity after the distribution is completed, and enabling one round of material lacking workstations to fall into one workstation group.

Preferably, a maximum inventory Maxₙ and a minimum inventory Minₙ of line side materials are set, and the line side inventory shall not exceed the maximum inventory. When the line side inventory is the minimum inventory, distribution tasks are arranged even if a loading rate of a vehicle is low.

Preferably, in step 5, according to the material pick frequency analysis, formula (1) denotes minimizing the total picking distance of all materials in a fixed period,

min Σₙ₌₁^{N}Σₐ₌₁^{A}Σ_{b=1}^{B}x_{nab}d_{ab}fₙ (1)

where d_{ab} is a travel distance from a b-th goods shelf in an a-th area to a picking working table, fₙ is an average pick frequency of a material n in a fixed period, s.t: ∀n, Σₐ₌₁^{A}x_{nab}=1, x_{nab}=1 means that an n-th type of parts are placed on the b-th goods shelf in an a-th area, otherwise it is 0, which means that one type of material can only be placed in one storage location.

Preferably, in step 5, the mathematical model established according to the material attribute analysis, the pick frequency analysis, the inter-material correlation and the material storage mode is shown in formula (2),

min Σₙ₌₁^{N}Σₐ₌₁^{A}Σ_{b=1}^{B}x_{nab}d_{ab}Fₙ (2)

where s.t: Fₙ=fₙ/Rₙ, ∀n, Σₐ₌₁^{A}x_{nab}=1 means that the n-th type of parts are placed on the b-th shelf in the a-th area, otherwise, it is 0.

Preferably, according to the inter-material correlation and the divided workstation groups, when two types of materials are in the same workstation group for more times, the correlation is greater, the materials with correlation are clustered, and a material correlation coefficient is defined as formula (3),

$${r}_{mn} = \frac{{p}_{mn}}{{Maxp}_{mn}} \qquad ( 3 )$$

where Pₘₙ denotes the number of times that materials m and n are in the same workstation group, rₘₙ denotes the inter-material correlation, rₘₙ∈[0,1], a new parameter is defined as a pick frequency Fₙ, Fₙ=fₙ/Rₙ, Rₙ=Σₙ₌₁^{N} rₘₙ correction of each type of material, and fₙ is an average pick frequency of the materials n in a fixed period.

The present invention has the following beneficial effects.

The material distribution method based on workstation group division enables the types and number of materials distributed to be more reasonable by design optimization of a distribution scheduling solution, thereby ensuring that a mixed-model assembly line is not subjected to material lacking and shutdown in the production process. The material distribution method reduces the quantity of the line side inventory, makes the work of distribution personnel more coordinated, reasonably plans the storage location of the warehouse, and improves picking efficiency.

### BRIEF DESCRIPTION OF THE DRAWINGS

FIG. 1 is a flowchart of workstation group division of a material distribution method;

FIG. 2 is a flowchart warehouse personnel's work in the material distribution method; and

FIG. 3 is a flowchart of distribution personnel's work in the material distribution method.

### DETAILED DESCRIPTION

The specific implementations of the present invention will be further described below with reference to the accompanying drawings and specific implementations.

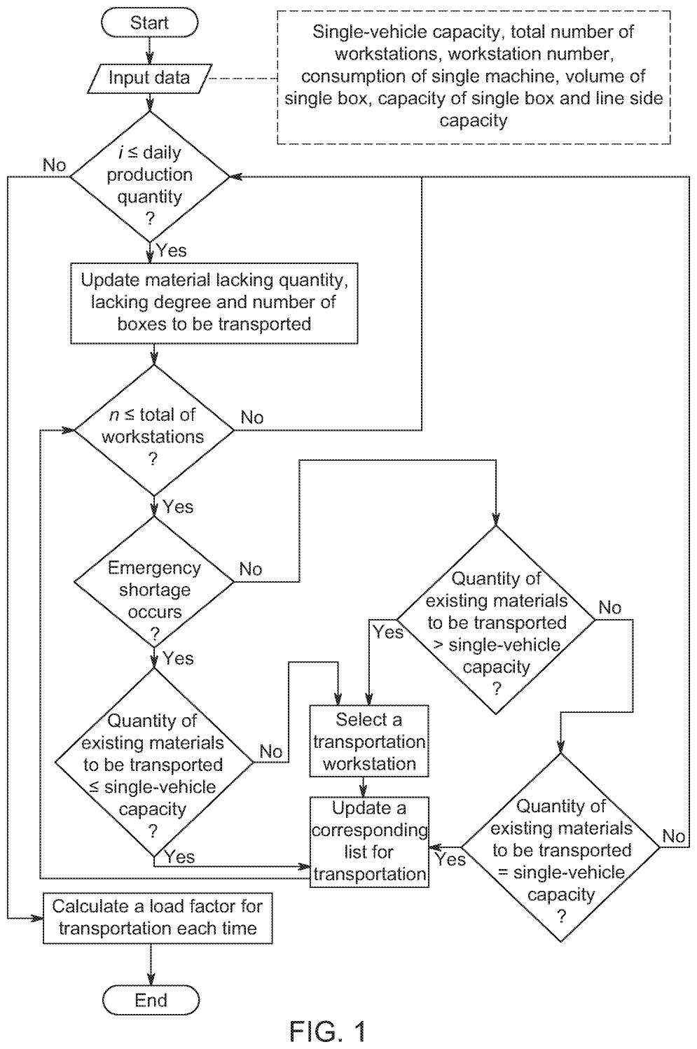

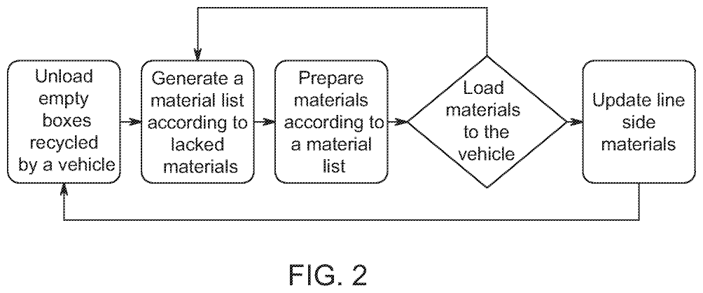

As shown in FIGS. 1-3, a material distribution method based on workstation group division includes the following steps.

Step 1: Set an RFID scanner at the first workstation where a production line starts, perform statistics on the number and models of online products, and take the number of online products as an indicator of a production process.

Step 2: Obtain material requirements of each product according to a BOM of the product, map the required materials to each workstation, and accordingly calculate material consumption at each material consumption workstation when an i-th product is produced.

Step 3: Check specific information on each type of material and transportation means according to the BOM, establish a mathematical model according to the specific information and the number of materials consumed, plan material distribution, and distribute materials for a workstation group Zj composed of the material consumption workstations when the i-th product is produced.

In step 3, the specific information on each type of material and transportation means includes information on material storage containers, types and sizes of material boxes, modes of combination of the material boxes, the number of stored materials and transportation capacity of the transportation means.

The workstation group division specifically includes: calculating a material demand lackᵢₙ of an n-th material consumption workstation for the production of an i-th product through the quantity of materials consumed for products, planning according to information on a material demand Coₙ of an n-th type of material for a unit product, a quantity Caₙ of materials in a unit material box, a material box volume Vₙ and a maximum carrying capacity Q of transportation means; when the number of material lacking boxes is equal to or greater than the maximum carrying capacity Q of the transportation means, distributing materials; where at this time, transportation workstations form a transportation workstation group; updating the material lacking quantity after the distribution is completed, and enabling one round of material lacking workstations to fall into one workstation group.

A maximum inventory Maxₙ and a minimum inventory Minₙ of line side materials are set, and the line side inventory shall not exceed the maximum inventory. When the line side inventory is the minimum inventory, distribution tasks are arranged even if a loading rate of a vehicle is low.

Step 4: Plan a distribution route of each workstation group according to the workstation group division.

Step 5: Obtain a distribution frequency of each type of material according to the workstation group division, and establish a mathematical model according to material attribute analysis, pick frequency analysis, inter-material correlation and a material storage mode to optimize a storage location of a warehouse.

A maximum inventory Maxₙ and a minimum inventory Minₙ of line side materials are set, and the line side inventory shall not exceed the maximum inventory. When the line side inventory is the minimum inventory, distribution tasks are arranged even if a loading rate of a vehicle is low. The conventional route planning is based on time, but now the route planning is based on the number of products produced. Since the factory assembly time is unstable, it is more accurate to base on the number of products.

A home appliance assembly line does not complete the assembly of the products on the line on the same day after the end of the production, so the counting can be continued in this way during the next day's production, and the line side inventory can be filled up before the production every day.

Taking a temporary material storage area as the center, the distribution route of each workstation group is reasonably planned according to the divided workstation groups and existing distribution channels of a factory.

For storage location optimization of a warehouse, attributes of materials, including weights, sizes, packaging forms, etc. thereof, are clarified first, since this determines a material storage method and a material selection storage method.

In step (5), according to the material pick frequency analysis, formula (1) denotes minimizing the total picking distance of all materials in a fixed period,

min Σₙ₌₁^{N}Σₐ₌₁^{A}Σ_{b=1}^{B}x_{nab}d_{ab}fₙ (1)

where d_{ab} is a travel distance from a b-th goods shelf in an a-th area to a picking working table, fₙ is an average pick frequency of a material n in a fixed period, the constraint condition of the model is that any n needs to satisfy: Σₐ₌₁^{A}x_{nab}=1, x_{nab}=1 means that an n-th type of parts are placed on the b-th goods shelf in an a-th area, otherwise it is 0, which means that one type of material can only be placed in one storage location.

In step 5, the mathematical model established according to the material attribute analysis, the pick frequency analysis, the inter-material correlation and the material storage mode is shown in formula (2),

min Σₙ₌₁^{N}Σₐ₌₁^{A}Σ_{b=1}^{B}x_{nab}d_{ab}Fₙ (2)

where s.t: Fₙ=fₙ/Rₙ, ∀n, Σₐ₌₁^{A}x_{nab}=1, x_{nab}=1 means that the n-th type of parts are placed on the b-th shelf in the a-th area, otherwise, it is 0.

According to the inter-material correlation and the divided workstation groups, when two types of materials are in the same workstation group for more times, the correlation is greater, the materials with correlation are clustered, and a material correlation coefficient is defined as formula (3),

$${r}_{mn} = \frac{{p}_{mn}}{{Maxp}_{mn}} \qquad ( 3 )$$

where Pₘₙ inn denotes the number of times that materials m and n are in the same workstation group, rₘₙ denotes the inter-material correlation, rₘₙ∈[0,1], a new parameter is defined as a pick frequency Fₙ, Fₙ=fₙ/Rₙ, Rₙ=Σₙ₌₁^{N}rₘₙ after correction of each type of material, and fₙ is an average pick frequency of the materials n in a fixed period.

Step 6: Divide staff into warehouse material preparation personnel and distribution personnel, and distribute materials according to a work flow.

Take the distribution of freezer production materials as an example: Daily distribution tasks are set for an enterprise's freezer assembly line according to daily production plans, without optimizing the design of material distribution scheduling solutions. The materials distributed may not be required for actual production, while the required materials may not be distributed in place, resulting in that line side materials are excessively accumulated, materials required at the line side are not distributed untimely, and reasonable planning is lacked the storage location of the warehouse.

Step 1: Paste an RFID code of a corresponding model on an iron sheet of each freezer, set an RFID scanner at a starting point of an assembly line to perform statistics on the number and models of online products, and take the number of the online products as an indicator of a production process.

Step 2: Obtain material requirements of each product according to a BOM of the product, map the required materials to each workstation, and accordingly calculate how many materials are consumed at an n-th material consumption workstation when an i-th product is produced. Lackᵢₙ=i·Coₙ, Lackᵢₙ is the number of the total consumption of an n-th type of materials when the i-th product is produced, and Ln is the number of n types of materials consumed for a unit product. Because the production process is accompanied by distribution, lackᵢₙ is the actual demand, then lackᵢₙ=lackᵢₙ−Σⱼ₌₁^{M}Bₙⱼ, j is the workstation group number, M is the total number of workstation groups, and Bₙⱼ is the distribution quantity of the material n in the distribution of the workstation group j.

Step 3: According to the principle of distribution upon full load, when

$${\sum }_{n = 1}^{K} [ \frac{{lack}_{in}}{{Ca}_{n}} ] * {v}_{n} \geq Q ,$$

enable the corresponding workstations to fall into one workstation group.

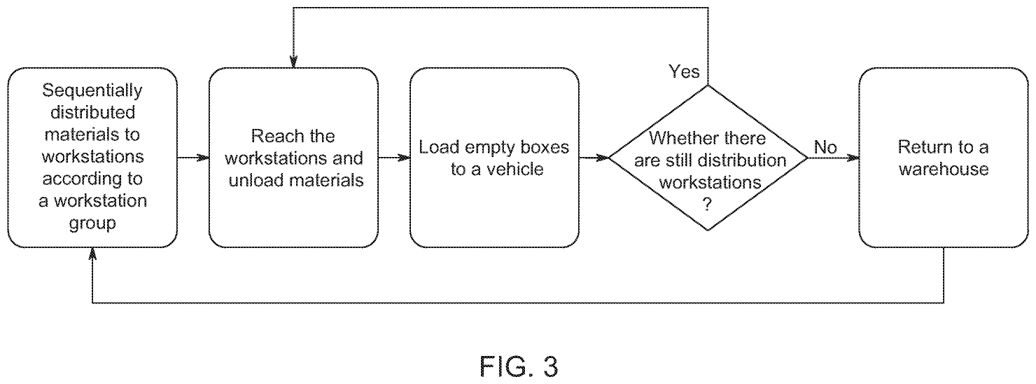

K is the total number of materials, Caₙ is the number of unit material boxes of n types of materials, Vₙ is the volume of material boxes of n types of materials, Q is the maximum loading capacity of transportation means, and when the quantity of materials to be distributed is greater than the loading rate of a vehicle, enable the corresponding workstations to fall into the same workstation group. In order to prevent too few line side materials from affecting the production, a maximum inventory Maxₙ and a minimum inventory Minₙ of line side materials are set, and the line side inventory shall not exceed the maximum inventory. When the line side inventory is the minimum inventory, corresponding workstation groups form a workstation group even if a loading rate of a vehicle is low. According to a mathematical model, MATLAB is used for solution to obtain the product material workstation group division. A procedure flowchart is shown in FIG. 3.

Step 4: Reasonably plan a distribution route of each workstation group according to the workstation group division, and distribute materials according to daily tasks. The distribution flow for distribution personnel is shown in FIG. 1.

Step 5: Obtain a distribution frequency of each type of material according to the workstation group division, and establish a mathematical model according to material attribute analysis, pick frequency analysis, inter-material correlation and a material storage mode to optimize the design of a storage location of a warehouse.

Step 6: Divide staff into warehouse material preparation personnel and distribution personnel.

It should be noted that the above description is not intended to limit the present invention, and the present invention is not limited to the above examples. Changes, modifications, additions or replacements made by those skilled in the art within the essential range of the present invention should fall within the protection scope of the present invention.

1. A material distribution method based on workstation group division, the method comprising:
step 1: setting a radio frequency identification (RFID) scanner at the first workstation where a production line starts, performing statistics on the number and models of online products, and taking the number of the online products as an indicator of a production process;
step 2: obtaining material requirements of each product according to a bill of materials (BOM) of the product, mapping the required materials to each workstation, and accordingly calculating material consumption at each material consumption workstation when an i-th product is produced;
step 3: checking specific information on each type of material and transportation means according to the BOM, establishing a mathematical model according to the specific information and the number of materials consumed, planning material distribution, and distributing materials for a workstation group Zj composed of the material consumption workstations when the i-th product is produced, wherein the specific information on each type of material and transportation means comprises information on material storage containers, types and sizes of material boxes, modes of combination of the material boxes, the number of stored materials and transportation capacity of the transportation means;
step 4: planning a distribution route of each workstation group according to the workstation group division, wherein
the workstation group division specifically comprises: calculating a material demand lackᵢₙ of an n-th material consumption workstation for the production of an i-th product through the quantity of materials consumed for products, planning according to information on a material demand Coₙ of an n-th type of material for a unit product, a quantity Caₙ of materials in a unit material box, a material box volume Vₙ and a maximum carrying capacity Q of transportation means; when the number of material lacking boxes is equal to or greater than the maximum carrying capacity Q of the transportation means, distributing materials; wherein at this time, transportation workstations form a transportation workstation group; updating the material lacking quantity after the distribution is completed, and enabling one round of material lacking workstations to fall into one workstation group; and a maximum inventory Maxₙ and a minimum inventory Minₙ of line side materials are set, and the line side inventory shall not exceed the maximum inventory; and when the line side inventory is the minimum inventory, distribution tasks are arranged even if a loading rate of a vehicle is low;
step 5: obtaining a distribution frequency of each type of material according to the workstation group division, and establishing a mathematical model according to material attribute analysis, pick frequency analysis, inter-material correlation and a material storage mode to optimize a storage location of a warehouse; taking a temporary material storage area as the center, and reasonably planning the distribution route of each workstation group according to the divided workstation groups and existing distribution channels of a factory; wherein:
according to the material pick frequency analysis, formula (1) denotes minimizing the total picking distance of all materials in a fixed period,
min Σₙ₌₁^{N}Σₐ₌₁^{A}Σ_{b=1}^{B}x_{nab}d_{ab}fₙ (1)
d_{ab} is a travel distance from a b-th goods shelf in an a-th area to a picking working table, fₙ is an average pick frequency of a material n in a fixed period, s.t: ∀n, Σₐ₌₁^{A}x_{nab}=1, x_{nab}=1 means that an n-th type of parts are placed on the b-th goods shelf in an a-th area, otherwise it is 0, which means that one type of material can only be placed in one storage location;
the mathematical model established according to the material attribute analysis, the pick frequency analysis, the inter-material correlation and the material storage mode is shown in formula (2),
min Σₙ₌₁^{N}Σₐ₌₁^{A}Σ_{b=1}^{B}x_{nab}d_{ab}Fₙ (2)
wherein s.t: Fₙ=fₙ/Rₙ, ∀n, Σₐ₌₁^{A}x_{nab}=1, and x_{nab}=1 means that the n-th type of parts are placed on the b-th shelf in the a-th area, otherwise, it is 0; and
according to the inter-material correlation and the divided workstation groups, when two types of materials are in the same workstation group for more times, the correlation is greater, the materials with correlation are clustered, and a material correlation coefficient is defined as formula (3),
$${r}_{mn} = \frac{{p}_{mn}}{{Maxp}_{mn}} \qquad ( 3 )$$
wherein Pₘₙ denotes the number of times that materials m and n are in the same workstation group, rₘₙ denotes the inter-material correlation, rₙₘ∈[0,1], a new parameter is defined as a pick frequency Fₙ, Fₙ=fₙ/Rₙ, Rₙ=Σₙ₌₁^{N}rₘₙ after correction of each type of material, and fₙ is an average pick frequency of the materials n in a fixed period; and
step 6: dividing staff into warehouse material preparation personnel and distribution personnel, and distributing materials according to a work flow.

2-7. (canceled)
